(19) United States
(12) Patent Application Publication
(10) Pub. No.: US 2025/0369497 A1
(43) Pub. Date: Dec. 4, 2025

(54) METHOD AND APPARATUS FOR VIBRATIONAL DAMPENING

(71) Applicant: Valmont Industries, Inc., Omaha, NE (US)

(72) Inventors: Carl J. Macchietto, Omaha, NE (US); Joshua Gourley, Omaha, NE (US)

(73) Assignee: Valmont Industries, Inc., Omaha, NE (US)

(21) Appl. No.: 19/214,350

(22) Filed: May 21, 2025

Related U.S. Application Data
(60) Provisional application No. 63/653,253, filed on May 30, 2024.

(51) Int. Cl. F16F 7/108

(52) U.S. Cl. CPC F16F 7/108; F16F 2222/08; F16F 2224/0208; F16F 2234/02

(57) ABSTRACT

A damper having an outer tube wall which includes upper and lower surfaces that together enclose a central cavity. According to a further preferred embodiment, the improved damper preferably includes a steel rod that is vertically aligned and enclosed within the central cavity. The bottom surface of the steel rod is preferably in frictional contact with a bearing that allows the bottom surface to translate laterally across the bearing. The bearing is preferably secured by a bearing support bracket to a bearing stand and/or directly to the lower surface of the outer tube wall.

### RELATED APPLICATIONS

The present application claims priority to U.S. Provisional Application No. 63/653,253 filed May 30, 2024.

### FIELD OF INVENTION

The present invention is related in general to vibration dampening and, in particular, to a method and apparatus for providing second-mode vibration damper enhancement of vertical pole-type structures.

### BACKGROUND OF THE INVENTION

Mass dampers are devices mounted in structures to reduce mechanical vibrations. Mass dampers have several applications, including protection of utility poles (e.g., electrical transmission, lighting, communication, camera, and the like), which are subjected to road and wind-induced vibrations. Utility poles are commonly mounted to concrete structures and therefore transmit received vibrations into their mounting structures. Further, when the road or wind excitations are near the natural frequencies of the utility pole or attached structures, harmonic resonances can be created, which can cause significant damage due to fatigue.

Impact dampers are one type of mass damper that has been used to protect utility poles and related structures. Common impact damper designs include enclosed weights, which are designed to move and impact the sides of closed containers to dissipate vibrational energy. For example, U.S. Pat. Nos. 7,871,186 and 9,593,828 disclose the use of weighted balls which dissipate vibrations by impacting on the walls of a sealed damper chamber. Similarly, U.S. Patent Pub. No. US20110017562 to Hapco and WIPO Publication No. WO2023227182A1 to Engiso each disclose oscillating rods that impact the sides of closed chambers.

Each of the prior art solutions have important limitations. In particular, the oscillating rod solutions proposed by Hapco and Ensigo teach designs in which an enlarged rod-shaped mass must be excited by significant vibrational forces so that the inclination of the rod is forcibly changed. For this reason, the solutions provided by Hapco, Ensigo, and related prior art are limited to vibrational damping for vibrations exceeding significant fixed thresholds. Accordingly, these solutions provide no true dampening for a variety of consistent but lower levels of vibrational inputs. Further, the prior art solutions require oversized enclosures using significant weights, which are often ill-suited for smaller pole structures. Accordingly, an improved vibrational damper is needed to allow for a fuller absorption of a wider range of vibrational frequencies and displacement amplitudes, while having a more compact design with an overall lower weight.

### SUMMARY OF THE DISCLOSURE

To minimize the limitations found in the prior art, and to minimize other limitations that will be apparent upon the reading of the specifications, aspects of the present invention preferably include a method and apparatus of providing second-mode vibration damper enhancement. According to preferred embodiments, the present invention teaches a cannister damper which is specifically designed to more efficiently and effectively translate an internally stored mass within a sealed container.

According to a first preferred embodiment, the improved damper of the present invention preferably may include an outer tube wall which includes upper and lower surfaces that together enclose a central cavity.

According to a further preferred embodiment, the improved damper preferably includes a steel rod that is vertically aligned and enclosed within the central cavity. The bottom surface of the steel rod is preferably in frictional contact with a bearing that allows the bottom surface to translate laterally across the bearing. The bearing is preferably secured by a bearing support bracket to a bearing stand and/or directly to the lower surface of the outer tube wall.

These and other advantages and features of the present invention are described with specificity to make the present invention understandable to one of ordinary skill in the art.

### BRIEF DESCRIPTION OF THE DRAWINGS

Elements in the figures have not necessarily been drawn to scale to enhance their clarity and to improve understanding of these various elements and embodiments of the invention. Furthermore, elements that are known to be common and well understood by those in the industry are not depicted to provide a clear view of the various embodiments of the invention. Thus, the drawings are generalized in form in the interest of clarity and conciseness.

FIG. 1 is a side view of an exemplary light pole fitted with a dampening device in accordance with a first aspect of the present invention.

FIG. 2 is an enlarged view of the dampening device as indicated in FIG. 1.

FIG. 3 is a cross-sectional view of an exemplary dampening device in accordance with a first preferred embodiment of the present invention.

FIG. 4 is a cross-sectional view of the lower portion of the dampening device of the present invention, indicated in FIG. 3.

FIG. 5 is a perspective view of the outer tube bottom cap in accordance with a first preferred embodiment of the present invention.

FIG. 6 is a cross-sectional view of the lower portion of the dampening device of the present invention in accordance with an exemplary alternative embodiment of the present invention.

### DETAILED DESCRIPTION OF THE DRAWINGS

Reference is now made in detail to the exemplary embodiments of the invention, examples of which are illustrated in the accompanying drawings. Wherever possible, the same reference numbers will be used throughout the drawings to refer to the same or like parts. The description, embodiments, and figures are not to be taken as limiting the scope of the claims. It should also be understood that throughout this disclosure, unless logically required to be otherwise, where a process or method is shown or described, the steps of the method may be performed in any order, repetitively, iteratively, or simultaneously. As used throughout this application, the word “may” is used in a permissive sense (i.e., meaning “having the potential to’), rather than the mandatory sense (i.e., meaning “must”).

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification, and all such embodiments are intended to be included within the scope of that term or terms.

Further, various inventive features are described below that can each be used independently of one another or in combination with other features. However, any single inventive feature may not address any of the problems discussed above, or may only address one of the problems discussed above. Further, one or more of the problems discussed above may not be fully addressed by any of the features described below.

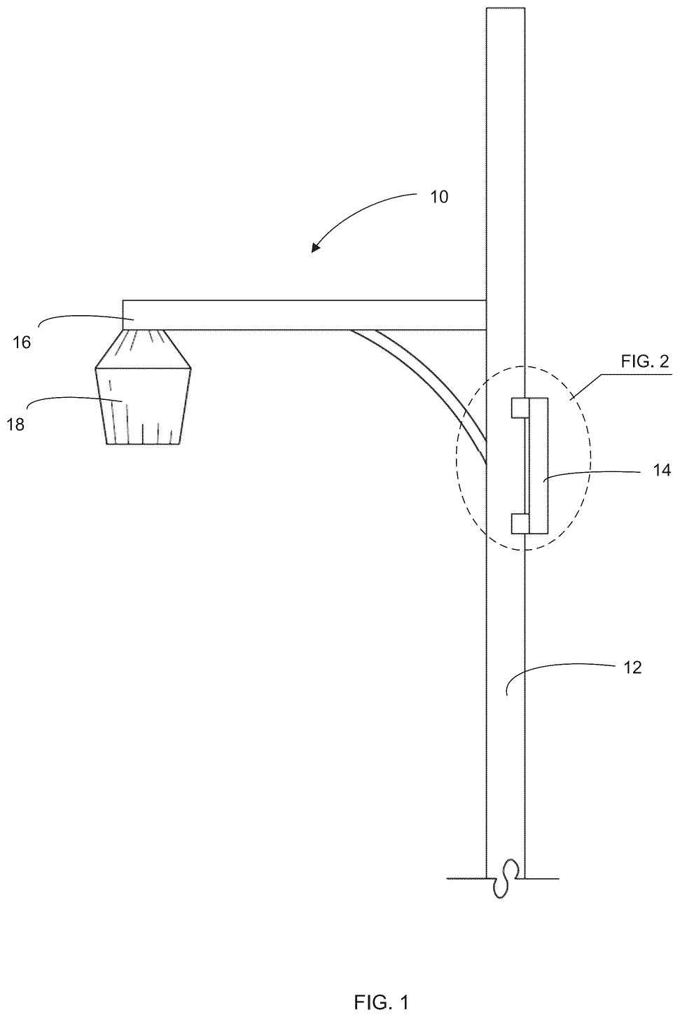

FIG. 1 illustrates a side view 10 of an exemplary utility pole 12 fitted with a dampening device 14 in accordance with a first aspect of the present invention. As shown, the exemplary dampening device 14 may preferably be positioned at the point of the maximum amplitude of a target vibration mode. For second mode vibration on a pole structure, this is approximately at ⅔rds of the length of the pole as measured from the ground. For a 1st mode vibration, the dampening device may preferably be positioned at or near the top of the pole. Further, although shown attached to the outside of the pole, the dampening device as shown and discussed herein may alternatively have different dimensions (i.e., it could be made thinner and longer) and may be incorporated within the pole 12 (out of view). The mounting of the dampening device 14 may be with any form of connector or clamp of conventional construction. As should be understood, the utility pole 12 is purely exemplary, and the present invention may be attached to any structure to achieve the advantages of the present invention.

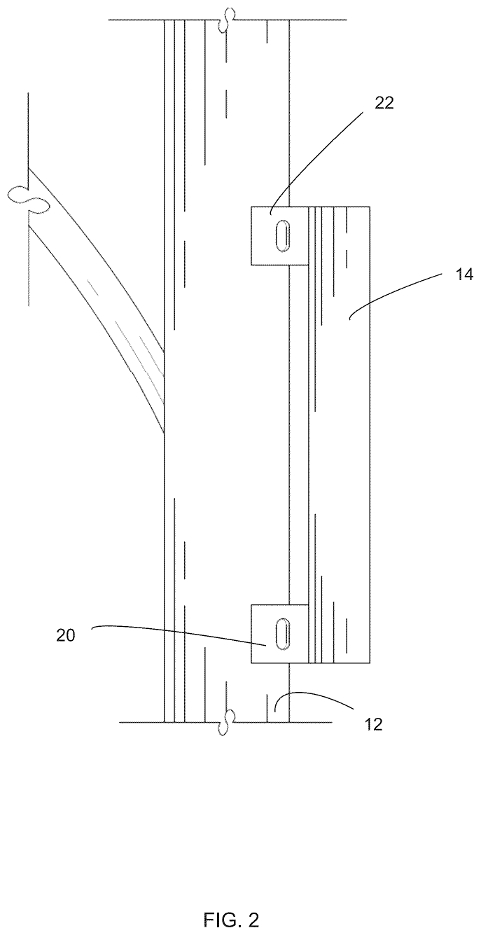

As further shown in FIG. 1, the utility pole 12 may preferably be further secured to a base and may preferably support a light 18. Alternatively, the structure represented by the utility pole 12 may further include a cantilevered arm 16 or the like and may support various objects such as signs, traffic lights, overhead wires, and the like. According to a further alternative preferred embodiment, the exemplary dampening device 14 of the present invention may alternatively be positioned in the mid and/or lower sections of the utility pole 12 as discussed further below. FIG. 2 provides an enlarged view of the pole section and attached dampening device 14. As shown, the dampening device 14 may be connected to the utility pole with a bottom connection bracket 20 and a top connection bracket 22. Alternative connection methods may be used without limitation.

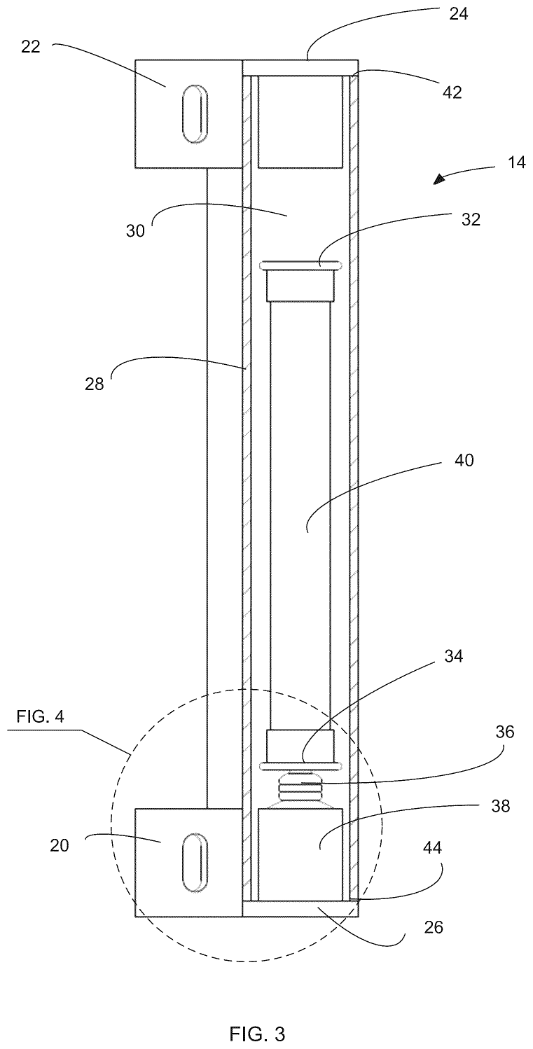

With reference now to FIG. 3, a cross-sectional view of an exemplary dampening device 14 in accordance with a first preferred embodiment of the present invention shall now be further discussed. As shown in FIG. 3, the dampening device 14 of the present invention may preferably include an outer tube wall 28 enclosing a central cavity 30. The outer tube wall 28, as shown, includes an upper surface 42 and a lower surface 44. The outer tube wall 28 may preferably be sealed at its upper surface 42 with an outer tube top cap 24. The outer tube wall 28 may be sealed at its lower surface 44 with an outer tube bottom cap 26. Preferably, the outer tube wall 28 encloses a central weighted bar 40. According to a preferred embodiment, the central weighted bar 40 may preferably be formed of steel or steel alloy, and may be shaped as a linear rod with a circular circumference. According to an alternative preferred embodiment, the outer tube wall 28 may be formed in the shape of a square or a rectangle. The central weighted bar 40 may preferably further include an inner tube upper cap 32 and an inner tube bottom cap 34. According to a further preferred embodiment, the interior surface of the outer tube wall 28 may be metal or may alternatively be covered with a deformable, impact-absorbing material such as plastic, stuffed fabric, or other padding-type materials. Furthermore, one or both of the inner tube upper cap 32 and the inner tube bottom cap 34 may be metal or may alternatively be covered with a deformable, impact-absorbing material such as plastic, stuffed fabric, or other padding-type materials

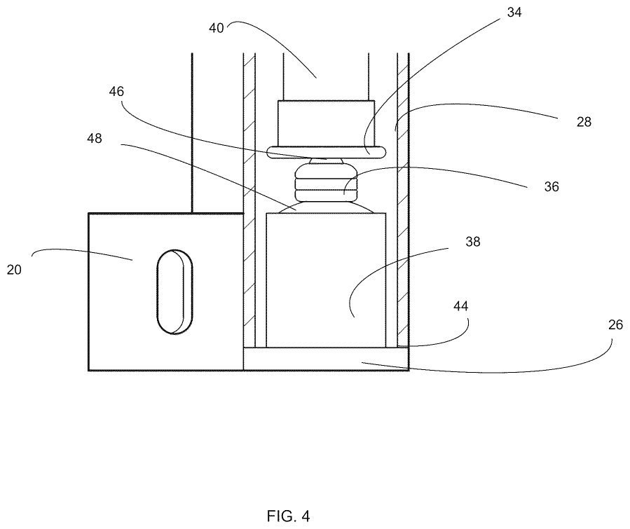

Referring now to FIG. 4, an enlarged view of the lower section indicated in FIG. 3 shall now be discussed. As shown, the dampening device 14 preferably may include a bearing stand 38 supporting a bearing support bracket 48. As further shown, the bearing support bracket 48 may preferably attach to and support a bearing housing 36. The bearing housing 36 preferably encloses a bearing 46 which is in frictional contact with the inner tube bottom cap 34. According to alternative embodiments, the bearing 46 could alternatively be attached directly to the bottom of the central rod 40. Still further, the present invention may alternatively include one or more loose ball bearings at the bottom of the tube enclosure/central cavity 30 with the central rod 40 in direct, frictional contact with the loose bearings. According to this alternative embodiment, the central rod 40 may be placed within the central cavity 30 with or without the inner tube upper cap 32, inner tube bottom cap 34, the bearing stand 38, and the like.

According to preferred embodiments, the bearing(s) for use with the present invention may preferably be a roller ball bearing, a Hudson bearing, or the like. Alternatively, the bearings for use with the present invention may include any number of designs. For example, the types of bearings used with the present invention may include angular contact bearings, axial/thrust ball bearings, deep-groove radial bearings, preloaded pairs, slot-fill radial bearings, row designs, caged bearings, flanged bearings, and the like. The bearings of the present invention may be formed from any of a variety of materials, including chrome steel, stainless steel, and/or ceramic varieties.

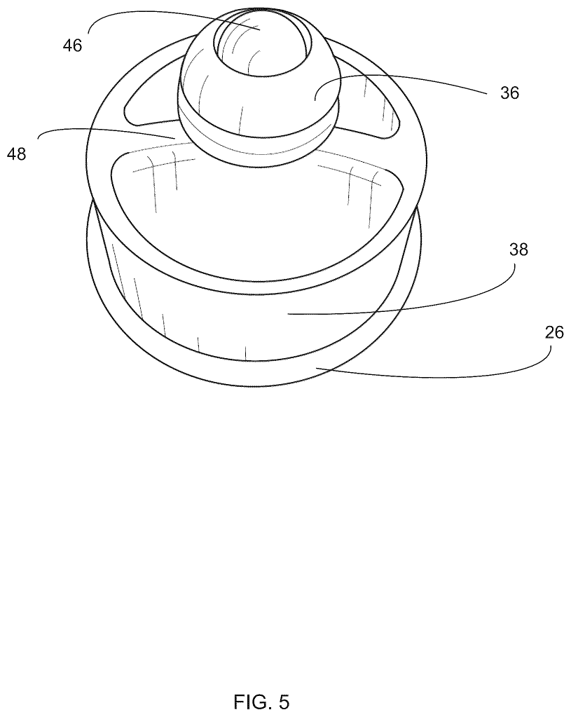

Referring now to FIG. 5, a perspective view of the outer tube bottom cap 26 in accordance with a first preferred embodiment of the present invention is provided. As shown, the outer tube bottom cap 26 preferably may be integrally formed with a lateral wall surface forming the bearing stand 38. The bearing stand 38 may preferably include cross-sectional framing elements forming one or more bearing support brackets 48. The bearing support brackets 48 may be attached via a screw, weldment, or other adhesive methods to the bearing housing 36 enclosing one or more bearings 46. According to a first preferred embodiment, the bearing housing 36 and bearing 46 may preferably be formed as a single Hudson bearing which is screwed into the bearing stand 38 and/or bearing support bracket 48. According to alternative embodiments, two or more bearing housings 36 may be used and attached at different points along one or more bearing support brackets 48.

In operation, the improved damper 14 of the present invention is preferably mounted on a utility pole 12 as discussed above. When the damper 14 is vibrated, the internal steel rod/bar 40 is preferably allowed to move independently from the outer tube wall 28. With sufficient force, the rod 40 may preferably move on the bearing(s) 46 and translate the entire mass of the rod 40 to laterally impact the side wall of the tube with the rod 40 remaining in a substantially upright, vertical orientation such that the main vertical axis of the rod 40 remains substantially parallel to the outer tube wall 28 (i.e. forming an angle of less than +/−) 5°. In this way, the entire mass of the rod 40 may be used to dampen vibrations, and the rod 40 may impact relatively flush with the side wall 28. By allowing the bottom of the rod to translate over with the vibration movement versus just rocking at the bottom pivot point, the present invention may preferably increase the mass effectiveness by having a greater proportion of the mass engaged by using the bearing. According to alternative embodiments, the dimensions of the side wall 28 and the rod 40 may be adjusted such that the rod 40 may translate on the bearing at an angle of +/−5°-25° (or at any range therebetween) relative to the side wall 28.

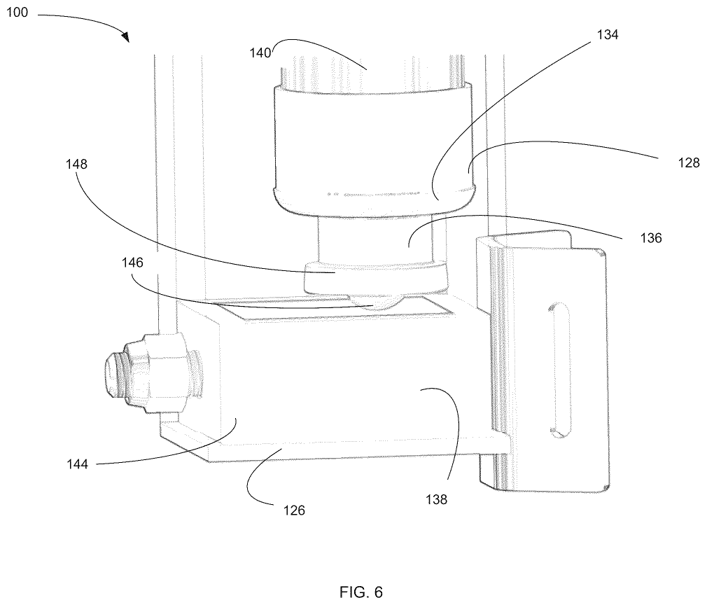

Referring now to FIG. 6, a cross-sectional view of the lower portion of the dampening device of the present invention in accordance with an exemplary alternative embodiment 100 of the present invention shall now be discussed. As shown in FIG. 6, the present invention 100 may alternatively be formed with the bearing 146 attached to the lower end of the weighted steel/bar rod 140. The dampening device 100 may preferably include a bearing stand 138 with an outer surface 144 and an outer tube bottom cap 126. The weighted steel/bar rod 140 may preferably include an inner tube bottom cap 134, which is attached to a bearing housing 136 and bearing support bracket 148, which preferably encloses a bearing 146, which is in frictional contact with the top surface of the bearing stand 138.

According to preferred embodiments, the bearing(s) for use with the present invention may preferably be a roller ball bearing, a Hudson bearing, or the like. Alternatively, the bearings for use with the present invention may include any number of designs. For example, the types of bearings used with the present invention may include angular contact bearings, axial/thrust ball bearings, deep-groove radial bearings, preloaded pairs, slot-fill radial bearings, row designs, caged bearings, flanged bearings, and the like. The bearings of the present invention may be formed from any of a variety of materials, including chrome steel, stainless steel, and/or ceramic varieties.

The foregoing description of the preferred embodiment of the present invention has been presented for illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A vibrational damper, wherein the vibrational damper comprises:
an outer tube wall, wherein the outer tube wall comprises an upper surface and a lower surface; wherein the outer tube wall forms a central cavity;
an outer tube top cap, wherein the outer tube top cap seals the upper surface of the outer tube wall;
an outer tube bottom cap, wherein the outer tube bottom cap seals the lower surface of the outer tube wall;
a weighted bar, wherein the weighted bar is enclosed within the outer tube wall; wherein the weighted bar comprises a steel rod;
a bearing stand, wherein the bearing stand is enclosed within the outer tube wall;
a bearing support bracket, wherein the bearing support bracket is attached to the bearing stand; and
a central bearing, wherein the central bearing is enclosed within a bearing housing;
wherein the bearing housing is attached to the bearing support bracket;
wherein the weighted bar is attached to an inner tube top cap at an upper surface and an inner tube bottom cap at a lower surface; wherein the weighted bar comprises a vertically aligned, steel rod;
wherein the inner tube bottom cap is in frictional contact with the bearing.

2. The vibrational damper of claim 1, wherein the central bearing is a roller ball bearing.

3. The vibrational damper of claim 2, wherein the roller ball bearing is a Hudson bearing.

4. The vibrational damper of claim 3, wherein an interior surface of the outer tube wall comprises an impact-absorbing material.

5. The vibrational damper of claim 4, wherein the weighted bar is substantially vertically aligned such that a main vertical axis of the weighted bar is oriented within ±5° of a vertical reference axis.

6. The vibrational damper of claim 1, wherein the bearing stand is integrally formed with the outer tube bottom cap.

7. The vibrational damper of claim 1, wherein the damper further comprises: a top connection bracket and a bottom connection bracket configured to secure the damper to a support structure.

8. The vibrational damper of claim 7, wherein the support structure is a utility pole.

9. The vibrational damper of claim 8, wherein the vibrational damper is positioned at approximately two-thirds of the length of the utility pole to dampen second-mode vibration.

10. The vibrational damper of claim 8, wherein the vibrational damper is positioned at or near a top portion of the utility pole to dampen first-mode vibration.

11. The vibrational damper of claim 1, wherein the central bearing is configured to permit lateral translation of the weighted bar within the central cavity such that the weighted bar impacts the outer tube wall during vibration.

12. The vibrational damper of claim 1, wherein the outer tube wall is at least partially formed of metal.

13. The vibrational damper of claim 1, wherein the weighted bar is formed of steel or a steel alloy and shaped as a linear rod.

14. The vibrational damper of claim 1, wherein the outer tube bottom cap includes at least one lateral wall surface forming the bearing stand and one or more bearing support brackets integrally extending therefrom.
